(19) United States
(12) Patent Application Publication
(10) Pub. No.: US 2012/0189681 A1
(43) Pub. Date: Jul. 26, 2012

(54) PHOTOCATALYTIC COATING FOR THE CONTROLLED RELEASE OF VOLATILE AGENTS

(76) Inventors: Carlos José Macedo Tavares, Guimaraes (PT); Femando Da Silva Pina, Nova de Lisboa (PT)

(21) Appl. No.: 13/387,616

(22) PCT Filed: Dec. 11, 2009
(86) PCT No.: PCT/IB2009/055716

§ 371 Date: Apr. 12, 2012

(30) Foreign Application Priority Data
Jul. 29, 2009 (PT) 104692

(51) Int. Cl. A01N 25/34; B01J 21/06; B01J 23/30; B01J 27/047; B01J 23/20; B01J 23/28; B01J 27/051; B01J 23/22; B01J 27/138; B01J 23/72; B01J 23/18; B01J 21/08; B01J 23/46; B01J 23/31; B01J 27/24; B01J 23/06; B01J 23/14; B01J 27/04; B01J 23/745; B01J 21/04; B01J 27/057; B01J 37/08; B01J 31/06; B01J 37/34; B32B 5/16; A01P 17/00; B82Y 99/00; B82Y 40/00; B82Y 30/00

(52) U.S. Cl. 424/408; 502/350; 502/305; 502/219; 502/353; 502/321; 502/220; 502/226; 502/345; 502/344; 502/232; 502/325; 502/311; 502/200; 502/343; 502/349; 502/216; 502/338; 502/355; 502/215; 502/100; 502/159; 502/5; 428/323; 428/327; 428/321.5; 977/811; 977/902; 977/890; 977/773

(57) ABSTRACT

A layered heterostructured coating has functional characteristics that enable the controlled release of volatile agents. The coating has photocatalytic properties, since it uses titanium dioxide, its derivatives or materials with similar photocatalytic properties (2), which upon solar irradiation open and/or degrade nano or microcapsules (3) and subsequently releases in a controlled form the volatile agents contained in them.

### TECHNICAL DOMAIN OF THE INVENTION

The present invention is allocated in the functional coatings domain for the controlled release of volatile agents. This coating consists of a heterostructured material in layers that upon irradiation with solar light, or similar artificial sources of light, releases, in a controlled way, volatile agents. This layered heterostructured material consists of a photocatalytic coating in the form of a thin film deposited on a particular substrate (e.g. glass, ceramic, metal, polymer, textile, wood, stone, amongst others) and a colloidal suspension adsorbed on the photocatalytic film surface that contains the polymeric nano or microcapsules, which in turn host the volatile agent in a liquid form (insecticide, repellent, deodorant, perfume, amongst others). The applications range from medical, pharmaceutical, drug, biotechnology, sanitary, building and construction, cosmetic, perfume, automobile and food industries.

### BACKGROUND OF THE INVENTION

In a time of global warming one begins to recognize the insects as the bearers of illnesses or co-agents of bigger nuisance especially in the tourist areas. It has been verified that the contamination by contact with micro-organisms or insects yields an elevated impact in the public health. In order to minimise the contamination provided by the insects or micro-organisms, some solutions have been presented, such as the following.

It has been reported the production of a textile net impregnated with an insecticide, which possesses a high efficiency in repelling and killing airborne virus-carrying insects. Despite the guarantee that the insecticide/repellent properties are maintained after (undetermined) multiple washings and solar exposure, the low resistance of these textile fibres to prolonged ultraviolet (UV) radiation exposure (with inevitable ageing and fabric deterioration), the steep price and the empirical fact that the efficiency decreases with multiple washings, suggest further disadvantages.

Other textiles are known to have similar insecticide/repellent properties, where the textile fibres are covered with permethrin (a common synthetic chemical, widely used as an insecticide or insect repellent). This substance is degradable by solar light; hence there is a need to protect it by encapsulating it with a UV-resistant polymer capsule, which inevitably diminishes the efficiency of the original objective. Another important factor worth taking into account is that permethrin is also degradable after multiple washings.

Additionally, there is already in the market a particular type of fence that prevents the entry of airborne insects into the house premises, being the fenced structure impregnated with an insecticide; however, due to its mesh dimensions, some insects actually permeate these fences.

In recent years there has been a growing interest in the semiconductor area related with the development of photocatalytic materials. These developments related with the use of photocatalytic materials reside essentially in the production of bactericide and self-cleaning surfaces. Nowadays, some industrial glass manufacturers already supply self-cleaning glass panes for the building industry, with thickness ranging from 50-100 nm. These coatings on glass are more self-cleaning in nature due to their hydrophilic properties, instead of their photocatalytic nature; since, in order to have a very high transmittance, they are very thin and thus not very crystalline in microstructure, lacking also mechanical robusticity. These commercial coatings become hydrophilic upon solar illumination. In this process, when water droplets, which are adsorbed to the vertical exposed surface, decrease their contact angle between the liquid-vapour and liquid-solid interface, wetting this surface, by gravity the water drains away organic pollutants that are either weakly adsorbed or photocatalically mineralised on that surface.

Some microcapsules for medical applications are known to promote the controlled release of drugs/narcotics, occasionally more than one agent simultaneously. These microcapsules are made of a biodegradable polymer. In the present invention, the objective is to use sunlight (or artificial light with the same electromagnetic spectra) in order to unchain via photocatalytic mechanisms the mineralization, dissociation and degradation of the polymeric walls that form either the nano or micropasules containing the volatile agent. Naturally, the conjugation of biological and photocatalytic processes can be applied.

The document of patent WO2007051198 reports the micro encapsulation technique of volatile agents whose release is controlled by the opening of pores. These nano or microcapsules do not rely on photocatalysis—that is, they do not degrade by means of oxidation-reduction (redox) mechanisms activated by solar light, however they respond to sunlight by opening its pores. The disadvantage relatively to the present invention is that it is not possible to regenerate the surface when the volatile agent is depleted.

Regarding photocatalytic coatings with the incorporation of titanium dioxide, the documents of patent JP2003096399A and JP2004188325 contemplate the use of porous microspheres with photocatalytic properties that have the potential of, when illuminated by solar or compatible radiation, to deodorize the ambient air through the volatile composite degradation that adsorbed in its surface. These microspheres act as air purifiers by degrading organic compounds resulting from airborne domestic vapours, such as from tobacco/cigarette smoking, human odour, amongst others when deposited on their surfaces. However, these photocatalytic microcapsules function by dissociating adsorbed organic compounds, that is, they only degrade the composites that are deposited on their surface. On the other hand, this type of processes compels to the regeneration of the active layer, including the titanium dioxide nanoparticles in the porous microspheres, becoming the inherent process expensive, complex, and potentially harmful for the health since the constant replenishing of titanium dioxide can cause undesirable inhalation of these nanoparticles. There's a growing interest in solutions that promote the controlled release of volatile agents and that are safe, economical and easy to replenish, moreover those that are significantly increasing its activity and efficiency.

The present invention presents a physical-chemical technique for the release, for example, of insect repellents upon solar exposure. In the particular case of common house-hold insecticides and repellents, the present technology intends to replace them by a means of a process where they are automatically and continuously released from a heterostructured layered material, that comprises a photocatalytic film deposited on any given surface (e.g. glass, metal, ceramic, plastic, stone, wood, textile, etc.) upon activation by solar or artificial light (with similar irradiance levels and wavelength range). After the depletion of the micro or nanocapsules that host the volatile agent, which together with the photocatalytic thin film constitute the referred heterostructure, the photocatalytic surface can be replenished or recharged by simple spraying an aerosol containing the mentioned micro or nanocapsules. The principal advantages in using a photocatalytic coating material capable of dissociating and degrading micro or nanocapsules containing volatile agents by solar exposure resides particularly in the: optimization of the biological activity; possibility of deposition of this heterostructured material in various types of surfaces (e.g. glass, plastic, ceramic, metal, stone, wood, textile, etc.); replenishing of the volatile agent (insecticide, repellent, perfume, deodorant) by aerosol spraying, reducing thus the costs with the regeneration of the volatile compounds.

### SUMMARY OF THE INVENTION

The present invention refers to a heterostructured material that comprises a functional coating that enables the controlled release of volatile agents. This coating is photocatalytic, composed by titanium dioxide or its derivatives or similar materials with appropriate photocatalytic properties, and nano or microcapsules that when exposed to solar radiation (or similar artificial light) promotes the controlled release of volatile agents contained in them. This heterostructured material can be applied in substrates of different types of materials, as for example glass, metal, ceramics, textile, polymers, wood, stone, amongst others, by physical or chemical deposition techniques.

The principal advantages in using a photocatalytic coating material capable of dissociating and degrading micro or nanocapsules containing volatile agents by solar exposure resides particularly in the: optimization of the biological activity; possibility of deposition this heterostructure in various types of surfaces (e.g. glass, plastic, ceramic, metal, stone, wood, textile, etc.); replenishing of the volatile agent (insecticide, repellent, perfume, deodorant) by aerosol spraying, reducing thus the costs with the regeneration of the volatile compounds.

### GENERAL DESCRIPTION OF THE INVENTION

The present invention consists of a layered coating structure containing a photocatalytic material in the form of a colloidal suspension or thin film (which can be titanium dioxide or derivatives of the form TiₓO_{y}, or other similar photocatalytic material) that upon solar illumination (or equivalent artificial light) is capable of opening by degrading/dissociating the polymeric walls of the nano or microcapsules that are adsorbed on photocatalytic material surface, promoting subsequently the controlled release of a volatile agent. The controlled release is dependent of the illumination time, irradiance and wavelength range. This activation by solar (preferably UV-A) light initiates oxidation-reduction (redox) mechanisms on the surface of the photocatalytic material, resulting in the mineralization of and subsequent opening of the pores, dissociation and initiation of degradation, of the polymeric nano or micro nanocapsules the host the volatile agent, promoting its release with time. These nano or microcapsules hosting the volatile agent are submicron carriers constituted by a lipophilic nucleus surrounded by a polymeric wall stabilised by tensoactives.

The deposition of this heterostructure, as schematised in FIG. 1, can be applied to various types of substrates, such as glass, plastic/polymer, ceramic, metal, stone, wood, textile, etc. Before deposition, these substrates need to be cleaned in an ultrasonic bath, composed of equal parts of acetone and ethanol, during 15 minutes. The photocatalytic material can be deposited, for instance, by physical techniques, commonly associated with thin film deposition or sythesis of nano particles or clusters, such as: reactive or non-reactive DC or RF physical vapour deposition (also known as magnetron sputtering, PVD), and associated plasma techniques; cathodic arc sputtering (arc-PVD); filtered vacuum arc deposition (FVAD); chemical vapour deposition (CVD), including spray-CVD; plasma enhanced chemical vapour deposition (PE-CVD); Low- or High-pressure Metalorganic Chemical Vapour Deposition (LP or HP-MOCVD); pulsed laser ablation deposition (PLAD); atomic layer deposition (ALD); vacuum or atmospheric plasma spraying; spray pyrolysis; thermal or electron beam evaporation; or by chemical deposition techniques also associated with the deposition of thin films or nano particles or nano clusters, such as: colloidal suspensions; Langmuir-Blodgett films; sol-gel films; spin-coating; amongst other physical-chemical techniques.

The regeneration or replenishing of these controlled vapour release surfaces with time can be done by spaying or pulverising the photocatalytic surface with a colloidal suspension or aerosol containing the nano or microcapsules hosting the volatile agent to be released. Therefore, after the photocatalytic material is deposited on a particular surface (e.g. glass window, lamps, furniture, tiles, cloth, net, etc.) there is no need to deposit it again, only to replenish the surface occasionally with the nano or microcapsules hosting the volatile agent(s) to be released.

The photocatalytic material consists e.g. of a semiconductor thin film of titanium dioxide (titania) or derivatives of the form TiₓO_{y}, which can be further cationic doped (e.g. with iron, nickel, silver, gold, neodymium, niobium, amongst others cations) or anionic doped (e.g. with fluorine, carbon, sulphur, nitrogen, boron, amongst other anions), or alternatively e.g. a semiconductor thin film of another type of photocatalyst whose energetic band-gap enables the absorption of UV-A and visible light photons from solar or artificial light, such as from the following compounds or derivatives: WO₃, WS₂, Nb₂O₅, MoO, MoS₂, V₂O₅, MgF₂, Cu₂O, NaBiO₃, NaTaO₃, SiO₂, RuO₂, BiVO₄, Bi₂WO₆, Bi₁₂TiO₂₀, NiO—K₄NB₆O₁₇, SrTiO₃, Sr₂NbO₇, Sr₂TaO₇, ZnO, ZrO₂, SnO₂, ZnS, CaBi₂O₄, Fe₂O₃, Al₂O₃, Bi₂O₆, Bi₂S₃, CdS, CdSe. For any of these photocatalytic materials it is expected that their intrinsic properties be maintained within a maximum variation of 15% in the atomic composition and stoichiometry of its elemental constituents. Furthermore, any of these given materials can be further optimised in order to absorb more light from the solar spectra, namely radiation from the visible part of the electromagnetic radiation spectrum. For the particular case of titanium dioxide, one of the most renown, efficient and commonly used photocatalysts, it must have semiconductor properties, have a energy band-gap ranging from 2.75 to 3.35 eV, in order to absorb UV-A and visible light from solar illumination or artificial lighting environments. The energy band-gap can be further reduced, in order to absorb more visible light and thus yield a higher photocatalytical efficiency response, if in the physical/chemical synthesis of this material it is anionic- or cationic-doped. Anionic doping provides a better result, by simultaneously decreasing the band-gap, increasing the absorption of visible light and inhibiting electron-hole recombination, thus increasing the potential of the redox mechanisms to dissociate the organic structure of the polymeric nano or microcapsules that host the volatile agent. The following chemical elements can be used for the aforementioned anionic-doping effect in the titanium dioxide structure: B, C, N, O, F, P, S. Alternatively, cationic-doping of titanium dioxide can be achieved with the inclusion of: Zr, Hf, V, Nb, Nd, Ta, Cr, Mo, W, Cu, Ag, Au, Fe, Pd, Pt). In both cases, the dopant concentration can be varied to a maximum of 10% in atomic composition, guaranteeing that the structural, optical (e.g. specially transmission for the case of glass windows), mechanical robusticity and photocatalytic properties are not prejudiced. The coating thickness can be in the range of 50-2500 nm, in order to avoid the accumulation of either thermal stresses for thinner films or compressive intrinsic stresses for thicker ones, which has the detrimental effect of spallation of the deposited film. It is desired that the surface area of the nano crystalline grains constituents of the photocatalytic material surface be in the range of 150-350 g/m², in order to maximise the surface area that is available for the adsorption of the nano or microcapsules that host the volatile agents. In the case of coatings on glass substrates, and for the particular case of a titanium dioxide photocatalytic thin film, the refractive index must be optimised in order that the coating retains a high transmittance for visible light wavelengths (400 to 700 nm), having values between 2.4 and 2.6. The crystallinity of the coating is also an important factor to be taken into account, and the appropriate methods must be endured in order to enhance this features, such as by controlling and optimising deposition parameters, thermal treatments, amongst other methods.

When using titanium dioxide as the photocatalytic coating, it is important to promote:
an adequate compound stoichiometry, in order to favour the development of polymorph crystalline phases that enhance the photocatalytic efficiency. In particular, for the composition type TiₓO_{y}, with 0.25<x<0.35 and 0.65<y<0.75, it is possible to produce the highly active anatase phase, which is photocatalitcally more active than rutile or brookite.
the enhancement of crystallisation by means of thermal treatments in vacuum or a low pressure reductive atmosphere at 500° C.; this treatment enhances the development of the anatase phase that in turn increases the photocatalytic efficiency.

These requisites are essential and must be endured in a similar form for titanium dioxide derivatives, doped with cations and/or anions, or for other materials with similar semiconductor and photocatalytic properties.

The choice of the photocatalytic material can be taken into account when considering the doping of existent materials in order to optimise the absorption of wider range of wavelengths from the solar electromagnetic radiation spectra, namely those from the visible light region. In particular, it is possible to obtain a blue shift by reducing the semiconductor optical band-gap by means of anionic substitutional doping in the titanium dioxide anatase lattice with nitrogen, carbon or sulphur atoms. This atomic doping level should not be more than 6%, in order to retain the ideal optical properties, namely the band-gap value and transmission of visible light, and also an optimum mechanical robusticity.

The nano or microcapsules, or colloidal particles, which are adsorbed on the photocatalytic coating, are of polymeric nature, having a wall thickness of a few nanometers with the added property of being degradable by means of redox mechanisms driven by solar light (or similar artificial light) illuminated on the photocatalytic titanium dioxide surface. These nano or microcapsules can be synthesised by the processing of the following polymers: parylene, poly(p-xylylenes), polylactic acid (PLA), polycaprolactone, derivatives of polyoxyethyl, ftalocianine, polyestyrene, acrylic forms, or other known natural-based polymers such as collagen, chitosan, chitin, polysaccharide-, cellulose- or amylose-based. This polymer film forms tensoactively the nano or microcapsule, which hosts the volatile agent to be freed. This volatile agent (can be e.g.: insecticide, repellent, perfume, deodorant) is dissolved in a volatile oil, such as cymbopogon citrates—also known as lemon grass, in order to enhance the release of the agent.

The synthesis of the nano or microcapsules, or colloidal polymeric particles, can be by chemical deposition or adsorption on the photocatalytic surface, by physical or chemical vapour deposition or simply by nano precipitation of a pre-formed polymer or by the evaporation of a solvent-based colloidal suspension.

Several types of nano or microcapsules can be used for the encapsulation of the volatile agent, when they deposited on the photocatalytic surface. An example is given regarding the strategy for the synthesis of the nano or microcapsules, which will yield the controlled release of the volatile agent by means of redox mechanisms o the photocatalytic thin film surface, as it is detailed in FIG. 2. A template matrix constituted by a colloidal particle, loaded with the volatile agent, is coated with successive layers of polycations and polyanions, forming thus the deposited Layer-by-Layer (LbL) structure. Subsequently the nucleus is dissolved or may remain intact.

The last step corresponds to the photo degradation of the polymer, resulting from oxidation-reduction mechanisms on the surface of the solar light-driven photocatalyst bottom layer, represented in FIG. 2.

From this simple solution, hard matrix templates, such as silica spherical particles or polystyrene networks can be used. Alternatively, soft matrix templates, such as copolymer or latex with surfactants can also be used. Furthermore, best results are expected from hard matrix templates made of agarose hydrogel in a water-in-oil type of emulsion. These nano or microspheres, previously loaded with the volatile agent, can be subsequently separated by centrifugation and suspended in water containing a positive polyelectrolyte, such as N,N-diethyl-N-methyl-ammonium, hydrochloride or polyalilamin. After washing and separating these spheres, they can be introduced on the negative polyelectrolyte, such as polystyrene sulphonate, polyvinyl sulphate, nafion. Several layers can be subsequently added, if necessary. The number of layers is an important for the determination of the controlled release rate of the volatile agent: the higher the number of layers the slower the release. This strategy can also be applied to flat surfaces such as of glass, textiles or on walls; being in this case the procedure much simpler, since the centrifugation step is omitted. For the particular case of flat surfaces with solar exposure, the use of an aerosol containing the nano or microcapsules loaded with the volatile agent is the better solution for replenishing the active surface once the controlled release of the respective volatile agent is reduced.

The invention enables the optimization of the biological activity due to: the photocatalytically-driven controlled release of the volatile agent under sunlight exposure; the replenishing or regeneration by means of aerosol spraying (for example) of the volatile agent (insecticide, repellent, perfume, deodorant) that is encapsulated within the polymeric nano or microcapsules, depending this frequency of replenishing on solar illumination and environment conditions; the reduction in maintenance costs, since once the photocatalytic layer is deposited on the chosen substrate (glass, plastic, ceramic, metal, stone, wood, textile, etc.) there is no need to replenish this active layer, solely the nano or microcapsules the host the volatile agent.

### BRIEF DESCRIPTION OF THE FIGURES

FIG. 1—Scheme that represents the layers and heterostructured material that is composed of: a substrate (1) that can be of several types, such as glass, plastic, ceramic, metal, stone, wood, textile, amongst others; a photocatalytic thin film (2) where subsequently the volatile agent-containing nano or microcapsules (3) can be adsorbed onto.

FIG. 2—Scheme that illustrates the sequence of the Layer-by-Layer deposition process. A matrix template (4) constituted by a colloidal particle loaded with the volatile agent (5) is coated by successive layers of polycations and polyanions, forming thus the Layer-by-Layer structure (6). In the next stage the nucleus is dissolved (7) or remains intact. The last step corresponds to the photo degradation driven by solar light (h n) (8) of the polymer that subsequently promotes the release of the volatile agent (9).

### DETAILED DESCRIPTION OF THE INVENTION

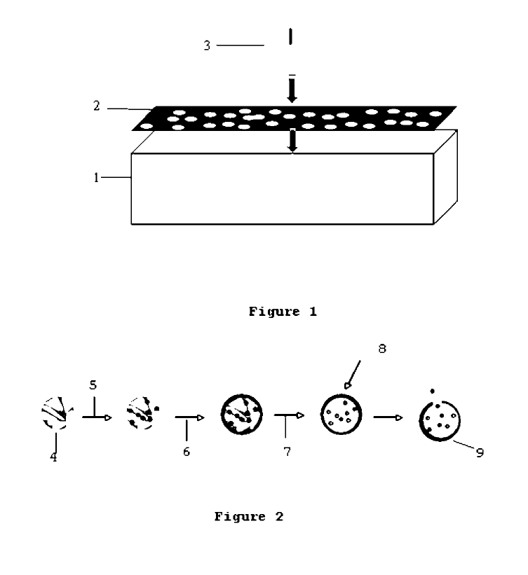

In FIG. 1 it is illustrated the 3 stages of the application of the materials that constitute the layered heterostructure that it is intended to be patented. First it is chosen a substrate, which can be of most types of materials such as glass, plastic/polymeric, ceramic, metal, stone, wood, textile, amongst others. In this particular example, a soda-lime glass substrate is chosen with 20 cm×20 cm in area and 1.5 mm in thickness, afterwards it must be cleaned preferably in an ultrasonic bath composed of equal parts of ethanol and acetone, during 15 minutes, in order for the surface to become degreased and clean of any pollutants or impurities, dissolving also in this process any salts or carbonates that were previously adsorbed on the glass substrate. After this bath, the cleaned substrate is dried in air or blown with industrial nitrogen.

Next follows the deposition of the semiconductor photocatalytic thin film, considering for this particular example titanium dioxide as the photocatalytic active material. This photocatalytic material, in the form of a thin film, can be deposited by any technique associated with: Physical (PVD) or Chemical (CVD) Vapour Deposition, Atomic Layer Deposition (ALD), Pulsed Laser Ablation (PLD), Spin-coating, spray pyrolysis, Sol-gel or Langmuir-Blodgett films, amongst other deposition techniques. In the present example it is described the process by the technique of physical vapour deposition (PVD), coupled with an ultra-high vacuum deposition chamber, since it is a low cost technique and environmentally friendly, involving literally no waste. The choice of the photocatalytic material can be considered taking into account the doping of existent materials with that physical characteristic, in order to optimise the absorption of light from the solar spectra with higher wavelengths, namely from visible light.

In this example, the recommended technique for the nano or microcapsule synthesis consists of a matrix template constituted by colloidal particles loaded with the volatile agent, which are coated by successive layers of polycations and polyanions, forming thus the Layer-by-Layer structure. In the next stage the nucleus is dissolved or remains intact. The template matrixes can be made of agarose hydrogel nano or microspheres, in emulsion water-in-oil type. After being loaded with the volatile agent, these nano or microspheres can be separated by centrifugation and suspended in water containing a positive polyelectrolyte (N,N-diethyl-N-methyl-ammonium). After washing and separation, these nano or microspheres can be introduced in the negative polyelectrolyte (polystyrene sulphonate). Several layers can be added, being this number of layers a parameter that will rule the degree of controlled release of the volatile agent from within the nano or microcapsules; the smaller this number the easier the volatile agent is released. It is expected that a minimum of solar light irradiance of 20 W/m² will be sufficient to promote the controlled release of the repellent.

### Example

For an easier comprehension of the invention, the following example describes in detail the preferential realizations of the invention, which, however, does not imply to limit the objective of the present invention.

In this example, it is intended to deposit on a glass substrate a thin film of TiO₂ doped in an anionic form with nitrogen, enabling the absorption of more visible light by the reduction of the semiconductor bang-gap. From a magnetron loaded with a pure titanium target, in an argon atmosphere (50-60 sccm inlet; sccm stands for standard cubic centimetre per minute) the deposition process is initiated by means of reactive magnetron sputtering of this material. For this particular case, a titanium target with 10 cm in diameter and a thickness of 6 mm is glued to the magnetron. An electrical current of 0.5 to 1.5 A is applied to this target (cathode), resulting in an electric field in the range of 4000-7000 V/m, which is sufficient to ionize the argon working gas and to maintain a stable electron plasma crucial for the sputtering process. The ejected titanium atoms react with the oxygen that is inlet at a flow in the range of 6-10 sccm forming thus the titanium dioxide molecules that are subsequently condensed in the form of a thin film on the glass substrate. By introducing a very small content of reactive nitrogen gas (2 to 4 sccm) during this deposition process it is possible to substitutionally dope nitrogen atoms in oxygen sites within the titanium dioxide crystal structure that develops in the mentioned growing thin film, and subsequently enabling the reduction of this materials semiconductor band-gap. Before deposition, a high vacuum base pressure of at least 10⁻⁴ Pa is desirable, guaranteeing the deposition of pure titanium dioxide thin films that are doped with nitrogen and are free of any contaminants such as water vapour, carbon dioxide, solvents or other species. During the deposition process, the pressure is in the range of 0.2-0.5 Pa. With these parameters, it is possible to obtain a deposition rate of 1 μm (10⁻⁶ m) per hour, being necessary at least two hours to obtain, in this example, a thin film of TiO₂ doped with nitrogen (TiO₂:N) with a thickness of 2 μm. In these conditions, the elemental atomic percentage of the nitrogen doping level is expected to be in the range of 1-3%; this doping level can be verified with high resolution composition analytical spectroscopies, such as Rutherford Backscattering Spectroscopy (RBS) or X-Ray Photoemission Spectroscopy (XPS). In this way, the thin film retains a homogeneous structure, and the resulting coating a high optical transmission in the visible range, suitable for the deposition on transparent substrates such as glass windows, and also a mechanically robust and adherent to the glass substrate, able to sustain agents that can mechanically degrade its surface, such as is the case by cleaning, air and water erosion. In order to verify the crystallinity of the thin photocatalytic film, it is possible to use X-ray diffraction techniques (XRD), equipped with a copper anode (for example), and to verify if the thin films diffracts with high intensity Bragg peak at 2 q>>25.3°, which is associated with (101) reflections from the anatase polymporph phase. If this crystalline diffracted peak is weak in intensity it means that the crystalization process was retarded by detrimental thermodynamic unfavourable conditions, and thus that the coatings require an additional thermal annealing in a vacuum furnace at 500° C., with at maximum vacuum pressure of the order of 10⁻⁴ Pa, for a period of two hours.

For the nano or microcapsule synthesis (3), a polymer film is deposited with photodegradable properties. This polymer film will form the walls that will encapsulate the volatile agent. For the particular case of nanocapsules, these structures should have an outer diameter ranging from 20-200 nm, a wall thickness of 10 to 40 nm and a spherical volume between 10⁻²⁵ and 10^{-19 m3}. This nanocapsule synthesis can be performed, for example, from the evaporation of a solvent-based solution containing the colloidal suspension. The volatile agent (in this particular case, an insect repellent) is contained within the nanocapsules dissolved in a volatile oil, such as cymbopogon citrates, enabling its volatization in to the surrounding environment, in a controlled way.

In the present example, it is considered that the volatile agent is a synthetic insect repellent, commonly known as N,N-Diethyl-meta-toluamide (DEET). This repellent is dissolved (by 30%) in a volatile oil, such as cymbopogon citrates (lemon-grass), within the nano or microcapsule, in order to aid the volatization of the repellent.

Once the controlled release of the repellent is decayed substantially, rendering it inefficient, the use of an aerosol containing the nano or microcapsules loaded with the volatile agent (repellent) is the most practical way to replenish or regenerate the photocatalytic surface layer with new capsules for the continuous controlled release of the repellent.

One of the objectives of the present invention is to describe new heterostructured layered coatings constituted by a substrate; photocatalytic material; and nano or microcapsules.

In a preferential realization, the photocatalytic material is a thin film of titanium dioxide or one of its derivatives or another material with similar photocatalytic and semiconductor properties. The elemental atomic concentrations of the constituents of titanium dioxide (TiₓO_{y}) are to be in the range of 0.25<x<0.35 and 0.65<y<0.75.

In another preferential realization, the photocatalytic material should have semiconductor optical properties with a band-gap in the range of 2.75-3.35 eV, a thickness in the range of 50 to 2500 nm and a crystallite surface area in the range of 150-35 g/m².

In a preferential realization, the photocatalytic materials with similar photocatalytic and semiconductor properties as with titanium dioxide consist of the following compounds and their own derivatives: WO₃, WS₂, Nb₂O₅, MoO, MoS₂, V₂O₅, MgF₂, Cu₂O, NaBiO₃, NaTaO₃, SiO₂, RuO₂, BiVO₄, Bi₂WO₆, Bi₁₂TiO₂₀, NiO—K₄NB₆O₁₇, SrTiO₃, Sr₂NbO₇, Sr₂TaO₇, ZnO, ZrO₂, SnO₂, ZnS, CaBi₂O₄, Fe₂O₃, Al₂O₃, Bi₂O₆, Bi₂S₃, CdS, CdSe.

In another preferential realization, the nano or microcapsules are made from a polymeric film that is degradable by photocatalytic mechanisms and encapsulate a volatile agent.

In another preferential realization, the polymeric film that coats the nano or microcapsules can be synthesized from: parylene, poly(p-xylylenes), polylactic acid (PLA), polycaprolactone, derivatives of polyoxyethyl, ftalocianine, polyestyrene, acrylic forms, or other known natural-based polymers such as collagen, chitosan, chitin, polysaccharide-, cellulose- or amylose-based. This polymer film forms tensoactively the nano or microcapsule, which hosts the volatile agent to be freed.

In a preferential realization, the nano or microcapsule synthesis consists of a matrix template constituted by colloidal particles loaded with the volatile agent, which are coated by successive layers of polycations and polyanions, forming thus the Layer-by-Layer structure.

In a another preferential realization, after being loaded with the volatile agent, these nano or microspheres can be separated by centrifugation and suspended in water containing a positive polyelectrolyte (N,N-diethyl-N-methyl-ammonium).

In another preferential realization, after washing and separation, these nano or microspheres can be introduced in the negative polyelectrolyte (polystyrene sulphonate). Several layers can be added, being this number of layers a parameter that will rule the degree of controlled release of the volatile agent from within the nano or microcapsules.

In a preferential realization, the nanocapsules have an outer diameter ranging from 20-200 nm, a wall thickness of 10 to 40 nm and a spherical volume between 10⁻²⁵ and 10^{-19 m3}.

In another preferential realization, it is expected that a minimum of solar light irradiance of 20 W/m² will be sufficient to promote the controlled release of the repellent.

In another preferential realization, the volatile agent (e.g.: insect repellent) is dissolved in a volatile oil, such as cymbopogon citrates—also known as lemon grass, in order to enhance the release of the agent.

Another objective of the present invention is the synthesis of a layered heterostructured coating in agreement with the following steps:
choice of substrate, which can be of glass, plastic (polymer), metal, ceramic, stone, wood, textile, amongst others.
substrate cleaning, in an ultrasonic bath composed of equal parts of ethanol and acetone, during 15 minutes, in order for the surface to become degreased and clean of any pollutants or impurities, dissolving also in this process any salts or carbonates that were previously adsorbed on the substrate. After this bath, the cleaned substrate is dried in air or blown with industrial nitrogen.
choice of photocatalytic material.
deposition of the photocatalytic coating in the form of a thin film or synthesis of nano or micro particles or clusters, by physical or chemical vapour deposition (PVD or CVD), or similar techniques, or by laser ablation, spin-coating, spray pyrolisis, sol-gel or Langmuir-Blodgett techniques, atomic layer deposition, amongst others.
anionic doping of the photocatalytic material with nitrogen, obtained from a co-reactive inlet of nitrogen gas (with a flow of 2-4 sccm) during the sputtering deposition.
crystalline structural analysis of the photocatalytic coating, by using an X-ray diffractometer with a copper anode.
thermal treatment of the photocatalytic coating in vacuum, with at most a base pressure of 10⁻⁴ Pa at a temperature of 500° C., during two hours.
regeneration or replenishing of the photocatalytic surface by means of aerosol spraying the nanocapsules that contain within the volatile agent to be released (e.g.: insect repellent).

In a preferential realization, the physical vapour deposition (PVD reactive magnetron sputtering process) is performed from a pure titanium target (purity 99.99%) placed on the magnetron cathode, with an argon working gas and oxygen reactive gas in the range of 50-60 sccm and 6-10 sccm, respectively.

In another preferential realization, during the PVD process the reactive gas is enriched with a nitrogen flow rate in the range of 2-4 sccm in order to perform an anionic doping of the PVD-generated titanium dioxide molecules that condense as a photocatalytic thin film onto the chosen substrate.

In another preferential realization, the PVD process occurs in a vacuum chamber at a working pressure in the range of 0.2-05 Pa and a current of 0.5 to 1.5 A is applied to the magnetron cathode in order to ionize the argon working gas, being the target material a titanium disc with a thickness of 6 mm and with a diameter of 10 cm. The deposited nitrogen-doped titanium dioxide thin film has a thickness of 2 μm.

In an even more preferential realization, the PVD process is coupled with an ultra-high vacuum system.

The main application for this layered heterostructured coating material, aimed for the controlled release of volatile agents, contemplates medical, pharmaceutical, drug, biotechnology, sanitary, building and construction, cosmetic, perfume, automobile and food industries.

1. Heterostructured layered coating comprising:
substrate;
photocatalytic thin film;
nano or microcapsules.

2. Heterostructured layered coating comprising photocatalytic material having optical semiconductor properties.

3. Heterostructured layered coating according to claim 1, the photocatalytic thin film having a thickness in the range of 50-2500 nm.

4. Heterostructured layered coating according to claim 1, the photocatalytic thin film surface having a surface area in the range of 150-350 g/m².

5. Heterostructured layered coating according to claim 1, the photocatalytic material being titanium dioxide or titanium dioxide derivatives or another material with similar semiconductor and photocatalytic properties.

6. Heterostructured layered coating according to claim 1, the elemental atomic concentrations of the constituents of titanium dioxide (TiₓO_{y}) being in the range of 0.25<x<0.35 and 0.65<y<0.75.

7. Heterostructured layered coating according to claim 1, the photocatalytic materials with similar photocatalytic and semiconductor properties as with titanium dioxide consisting of the following compounds and their derivatives: WO₃, WS₂, Nb₂O₅, MoO, MoS₂, V₂O₅, MgF₂, Cu₂O, NaBiO₃, NaTaO₃, SiO₂, RuO₂, BiVO₄, Bi₂WO₆, Bi₁₂TiO₂₀, NiO—K₄NB₆O₁₇, SrTiO₃, Sr₂NbO₇, Sr₂TaO₇, ZnO, ZrO₂, SnO₂, ZnS, CaBi₂O₄, Fe₂O₃, Al₂O₃, Bi₂O₆, Bi₂S₃, CdS, CdSe.

8. Heterostructured layered coating according to claim 1, the nano or microcapsules containing a volatile agent inside aimed for controlled release.

9. Heterostructured layered coating according to claim 1, the nano or microcapsules being made from a polymeric film that is degradable by photocatalytic mechanisms and encapsulates a volatile agent.

10. Heterostructured layered coating according to claim 1, the polymeric film that coats the nano or microcapsules being synthesized from: parylene, polyp-xylylenes), polylactic acid (PLA), polycaprolactone, derivatives of polyoxyethyl, ftalocianine, polyestyrene, acrylic forms, or other known natural-based polymers including collagen, chitosan, chitin, polysaccharide-, cellulose- or amylose-based.

11. Heterostructured layered coating according to claim 9, wherein the nano or microcapsule synthesis consists of a matrix template including colloidal particles loaded with the volatile agent, the colloidal particles being coated by successive layers of polycations and polyanions, forming a the Layer-by-Layer structure.

12. Heterostructured layered coating according to claim 1, the nanocapsules having an outer diameter ranging from 20-200 nm.

13. Heterostructured layered coating according to claim 1, the nanocapsules having a wall thickness of 10 to 40 nm.

14. Heterostructured layered coating according to claim 1, the nanocapsules having a spherical volume between 10⁻²⁵ and 10⁻¹⁹ m³.

15. Process of synthesis of the hetero structured layered coating according to claim 1, comprising the following steps:
choosing the substrate,
cleaning the substrate,
choosing a photocatalytic material,
depositing the photocatalytic material,
doping of the photocatalytic material to form the thin film,
analysing a crystalline structure of the photocatalytic thin film,
thermally treating the photocatalytic thin film,
synthesizing the nano or microcapsules from a polymeric thin film,
embedding the nano or microcapsules with a volatile agent,
dissolving the volatile agent in cymbopogon citrates, in order to enhance the volatization of the agent,
replenishing of a surface of the photocatalytic thin film with the nano or microcapsules loaded with the volatile agent.

16. Process of synthesis of the heterostructured layered coating according to claim 15, the substrate comprising glass, polymer/plastic, textile, metal, stone, ceramic, or wood.

17. Process of synthesis of the heterostructured layered coating according to claim 15, the substrate being cleaned in an ultrasonic bath composed of equal parts of ethanol and acetone, during 15 minutes, in order for the surface to become degreased and clean of any pollutants or impurities.

18. Process of synthesis of the heterostructured layered coating according to claim 15, wherein the anionic doping of the photocatalytic material with nitrogen, is achieved from a co-reactive inlet of nitrogen gas (with a flow of 2-4 sccm) during the sputtering deposition.

19. Process of synthesis of the heterostructured layered coating according to claim 15, wherein the depositing the photocatalytic coating is in the form of a thin film, by physical or chemical vapour deposition (PVD or CVD), or similar techniques, or by laser ablation, spin-coating, spray pyrolisis, sol-gel or Langmuir-Blodgett techniques, or atomic layer deposition.

20. Process of synthesis of the heterostructured layered coating according to claim 19, wherein the physical vapour deposition process comprises PVD—reactive magnetron sputtering.

21. Process of synthesis of the heterostructured layered coating according to claim 19, the PVD process being performed from a pure titanium target (purity 99.99%) placed on a magnetron cathode, with an argon working gas and oxygen reactive gas in the range of 50-60 sccm and 6-10 sccm, respectively.

22. Process of synthesis of the heterostructured layered coating according to claim 19, the PVD process being coupled to an ultra-high vacuum system.

23. Process of synthesis of the heterostructured layered coating according to claim 19, wherein during the thin film deposition with the PVD, the total working pressure is 0.2 to 0.5 Pa.

24. Process of synthesis of the heterostructured layered coating according to claim 21, comprising applying a current of 0.5 to 1.5 A to the titanium magnetron cathode in order to ionize the argon working gas and initiate the sputtering process.

25. Process of synthesis of the heterostructured layered coating according to claim 21, the titanium target having a thickness of 6 mm and a diameter of 10 cm.

26. Process of synthesis of the heterostructured layered coating according to claim 15, the nitrogen-doped photocatalytic thin film having a thickness of 2 μm.

27. Process of synthesis of the heterostructured layered coating according to claim 15, the crystalline structural analysis of the photocatalytic coating being assessed by X-ray diffraction with a copper anode.

28. Process of synthesis of the heterostructured layered coating according to claim 15, wherein the thermally treating of the photocatalytic coating is performed in vacuum, with at most a base pressure of 10⁻⁴ Pa at a temperature of 500° C., during two hours.

29. Process of synthesis of the heterostructured layered coating in according to claim 15, the regeneration or replenishing of the photocatalytic surface being performed by aerosol spraying the nanocapsules that contain within the volatile agent to be released.

30. A process of using the heterostructured layered coating according to claim 1, comprising controllably releasing the volatile agents for medical, pharmaceutical, drug, biotechnology, sanitary, building and construction, cosmetic, perfume, automobile and food industries.
